(19) United States
(12) Patent Application Publication
(10) Pub. No.: US 2026/0122720 A1
(43) Pub. Date: Apr. 30, 2026

(54) METHOD AND APPARATUS OF SUPPORTING STATE TRANSITION OF NETWORK NODE

(71) Applicant: Lenovo (Beijing) Limited, Beijing (CN)

(72) Inventors: Jing Han, Beijing (CN); Lianhai Wu, Beijing (CN); Mingzeng Dai, Shanghai (CN); Haiming Wang, Beijing (CN); Ran Yue, Beijing (CN)

(73) Assignee: Lenovo (Beijing) Limited, Beijing (CN)

(21) Appl. No.: 19/115,590

(22) PCT Filed: Sep. 29, 2022
(86) PCT No.: PCT/CN2022/122653

§ 371 Date: Mar. 26, 2025

(51) Int. Cl. H04W 76/27; H04W 68/02

(52) U.S. Cl. CPC H04W 76/27; H04W 68/02

(57) ABSTRACT

Embodiments of the present application relate to a method and apparatus of supporting state transition of network node. An exemplary method may include: entering a RRC idle state in response to a release message; and entering a RRC connected state from the RRC idle state in response to receiving a paging message or a configured condition being satisfied.

### TECHNICAL FIELD

Embodiments of the present application generally relate to wireless communication technologies, especially to a method and apparatus of supporting state transition of network node, e.g., supporting state transition of a repeater.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

According to RP-222667, a work item is approved to study network-controlled repeater (NCR) in 3rd generation partnership project (3GPP), which includes an NCR-mobile termination (MT) and NCR-forwarding (Fwd). According to the work item, one technical problem to be solved is related to the state transition of the NCR, especially the NCR-MT. For example, how the repeater, e.g., the NCR-MT enters radio resource control (RRC) CONNECTED state (or mode) from RRC IDLE state (or mode) in the case that a gNB wants to send side control information to control the NCR-Fwd etc.

### SUMMARY OF THE DISCLOSURE

One objective of embodiments of the present application is to provide a technical solution of supporting state transition of network node, e.g., supporting state transition of an NCR or the like.

Some embodiments of the present application provide a repeater, e.g., a network controlled repeater, which includes: a transceiver; and a processor coupled to the transceiver, wherein the processor is configured to: enter a RRC idle state in response to a release message; and enter a RRC connected state from the RRC idle state in response to receiving a paging message or a configured condition being satisfied.

In some embodiments of the present application, the paging message is received from a radio access network (RAN) node based on a paging configuration including a RAN identity of the repeater. In some scenarios, the paging configuration is transmitted in the release message. The processor is configured to: store the paging configuration alone or user equipment (UE) context including the paging configuration at least in the RRC idle state.

In some embodiments of the present application, the paging message is received from a RAN node based on a core network (CN) identity of the repeater.

In some embodiments of the present application, the configured condition is expiry of a timer related to RRC connection establishment, and the processor is configured to: start the timer in response to entering the RRC idle state; and initiate a RRC setup procedure in response to the expiry of the timer.

In some embodiments of the present application, the configured condition is transmitted in the release message. In some scenarios, the processor is configured to: store the configured condition alone or UE context including the configured condition at least in the RRC idle state.

In some embodiments of the present application, the configured condition is periodic tracking area updating (TAU), and the processor is configured to: initiate the periodic TAU to enter the RRC connected state.

Some other embodiments of the present application provide a RAN node, e.g., a gNB, which includes: a transceiver; and a processor coupled to the transceiver, wherein the processor is configured to: transmit a release message to transit a repeater into a RRC idle state; and transmit side control information to the repeater after the repeater entering a RRC connected state from the RRC idle state, wherein the repeater entering the RRC connected state is in response to a paging message from the RAN node or a configured condition being satisfied.

In some embodiments of the present application, the processor is configured to: transmit the paging message to the repeater based on a paging configuration including a RAN identity of the repeater.

In some embodiments of the present application, the processor is configured to: transmit the paging message to the repeater based on a CN identity of the repeater.

According to some embodiments of the present application, the processor is configured to: request the CN identity of the repeater from a CN entity.

According to some other embodiments of the present application, the processor is configured to: transmit, to a CN entity, a request of requesting paging the repeater by CN with a user identity of the repeater for determining the CN identity; receive a response including the paging message to the repeater; and transmit the paging message to the repeater. In some scenarios, the processor is configured to: transmit, to the CN entity, information indicating success of paging the repeater in response to RRC connection being established between the RAN node and the repeater.

In some embodiments of the present application, the configured condition is expiry of a timer related to RRC connection establishment, and the processor is configured to: transmit configuration of the timer in the release message.

In some embodiments of the present application, the configured condition is periodic TAU, and the processor is configured to: transmit information indicating desired periodicity of the TAU to a CN entity.

Some yet other embodiments of the present application provide a method of supporting state transition of a repeater, e.g., a method performed by a repeater, which includes: entering a RRC idle state in response to a release message; and entering a RRC connected state from the RRC idle state in response to receiving a paging message or a configured condition being satisfied.

Given the above, embodiments of the present application provide a technical solution of supporting state transition of a repeater, e.g., supporting the NCR-MT entering the RRC connected state from the RRC idle state, so that the gNB can transmit side control information to the NCR-Fwd via the NCR-MT, and thus will facilitate the deployment and implementation of the NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 illustrates a schematic diagram of an exemplary wireless communication system according to some embodiments of the present application, wherein an exemplary network-controlled repeater is implemented.

FIG. 3 is a flow chart illustrating a method of supporting state transition of repeater according to some embodiments of the present application.

FIG. 4 is a flow chart illustrating an exemplary procedure of supporting state transition of NCR-MT according to some embodiments of the present application.

FIG. 5 is a flow chart illustrating an exemplary procedure of supporting state transition of NCR-MT according to some other embodiments of the present application.

FIG. 6 is a flow chart illustrating an exemplary procedure of supporting state transition of NCR-MT according to some yet other embodiments of the present application.

FIG. 7 is a flow chart illustrating an exemplary procedure of supporting state transition of NCR-MT according to some yet embodiments of the present application.

FIG. 8 is a flow chart illustrating an exemplary procedure of supporting state transition of NCR-MT according to some yet embodiments of the present application.

FIG. 9 illustrates a block diagram of an exemplary apparatus of supporting state transition of repeater according to some embodiments of the present application.

FIG. 10 illustrates a block diagram of an exemplary apparatus of supporting state transition of repeater according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

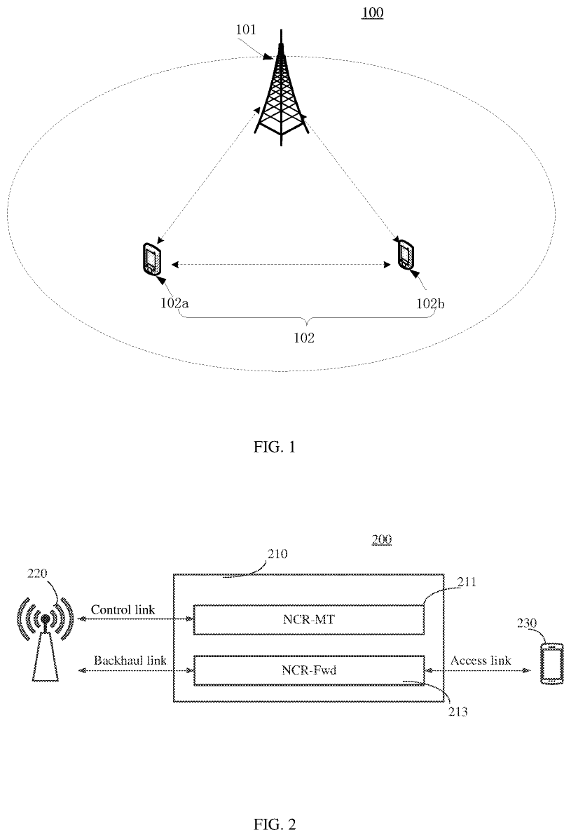

FIG. 1 illustrates a schematic diagram of an exemplary wireless communication system 100 according to some embodiments of the present application.

As shown in FIG. 1, the wireless communication system 100 includes a UE 103 and a base station (BS) 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

To enhance the coverage area of a BS, relay nodes, such as repeaters may be deployed in a wireless communication system, which can improve the throughput of a mobile device in low signal quality, e.g., a UE that locates in a coverage hole or far from the BS. A conventional repeater, e.g., a radio frequency (RF) repeater presents a cost effective means of extending network coverage. However, the RF repeater has its limitations. For example, the RF repeater simply does amplify-and-forward operations without the capability of taking into account various factors that could improve performance.

NCR is an enhancement over conventional RF repeaters, and has the capability of receiving and processing side control information (SCI) from the network. Side control information allows the NCR to perform its amplify-and-forward operation in a more efficient manner than RF repeaters. Potential benefits introduced by NCR include: mitigation of unnecessary noise amplification, transmissions and receptions with better spatial directivity, and simplified network integration.

FIG. 2 illustrates a schematic diagram of an exemplary wireless communication system 200 according to some embodiments of the present application, wherein an exemplary NCR 210 is implemented.

Referring to FIG. 2, the network-controlled repeater 210 is deployed between a BS 220, e.g., a gNB and a remote apparatus 230, e.g., a UE. The network-controlled repeater 210 can be modelled to include an NCR-MT 211 (MT of an NCR) and NCR-Fwd 213 (Fwd of an NCR). Regarding the NCR-MT 211, it is defined as a function entity to communicate with the gNB 220 via a C-link to enable exchange of control information, e.g. side control information at least for control of NCR-Fwd 213, wherein the C-link is based on NR Uu interface. Regarding the NCR-Fwd 213, it is defined as a function entity to perform the amplify-and-forwarding of RF signals on at least one of uplink (UL) or downlink (DL) (UL/DL) between the gNB 220 and UE 230 via the backhaul link and access link. The behaviors of the NCR-Fwd 213 will be controlled according to the received side control information from the gNB 220 via the NCR-MT 211.

It can be seen that the NCR-MT 211 is used to receive control information from the gNB 203 to control NCR-Fwd 2013. When the gNB needs to send side control information to control the NCR-Fwd 213 while the NCR-MT is in an idle state, e.g., a RRC idle state, the NCR-MT needs to enter the RRC connected state from the RRC idle state. Since there is no DL data from the CN dedicated for the NCR-MT 211, it implies that there is no paging from the CN to trigger the NCR-MT 211 to enter the RRC connected state. On the other hand, the network-controlled repeater 210 is transparent to the UE 230, which means that the UE 230 cannot discovery the network-controlled repeater 210 and cannot trigger the network-controlled repeater 210 to enter a RRC connected mode either.

At least to solve the above technical problem, embodiments of the present application propose a technical solution of supporting state transition of repeater or the like, e.g., a method and apparatus of supporting a repeater entering a RRC connected state (e.g., RRC CONNECTED state or mode) from a RRC idle state (e.g., RRC IDLE state or mode).

FIG. 3 is a flow chart illustrating a method of supporting state transition of repeater according to some embodiments of the present application. Although the method is illustrated in a system level by a repeater (e.g., a NCR) and a RAN node capable of control the repeater, e.g., a gNB, persons skilled in the art should understand that the method implemented in the repeater and RAN node can be separately implemented and/or incorporated by other apparatus with the like functions.

Referring to FIG. 3, it is assumed that a repeater, e.g., the repeater 210 shown in FIG. 2 has accessed to the network and has been identified (or authenticated, or authorized) by the network, e.g., by the CN or the RAN node. The RAN node, e.g., the gNB 220 shown in FIG. 2 may determine to send the repeater in a RRC connected state to a RRC idle state in some scenarios. The RAN node will transmit a release message, e.g., a RRC release message to the repeater in step 301. In response to the release message, the repeater will enter the RRC idle state.

For the repeater in the RRC idle state, a mechanism is needed to ensure that the repeater will transit into the RRC connected state from the RRC idle state to perform the amplify-and-forwarding of RF signals again. According to some embodiments of the present application, the repeater in the RRC idle state will enter the RRC connected state in response to receiving a paging message or at least one configured condition being satisfied in step 303, e.g., by initiating a RRC setup procedure or TAU etc. Consistently, in the network side, the RAN node may send side control information to the repeater if necessary after the repeater enters the RRC connected state from the RRC idle state in step 304.

The paging message can be configured and transmitted (or received) in various manners. For example, in some embodiments of the present application, the paging message is based on a paging configuration including a RAN identity of the repeater, e.g., a RAN identity of the MT of the repeater assigned by the gNB. The RAN node may initiate the paging and generate the paging message with the RAN identity of the repeater by itself. In some other embodiments of the present application, the paging message is based on a CN identity of the repeater, e.g., a CN identity of the MT of the repeater. In an exemplary scenario, the RAN node may request the CN identity of the repeater from a CN entity and generate the paging message with the CN identity of the repeater by itself. In another exemplary scenario, the RAN node may request a CN entity to generate the paging message with the CN identity of the repeater and then forward the received paging message with the CN identity entity to the repeater.

Similarly, there are also various configured conditions according to some embodiments of the present application. For example, a timer related to RRC connection establishment will be configured for the repeater. An exemplary configured condition is expiry of the timer. The repeater will initiate a RRC setup procedure in response to the expiry of the timer to enter the RRC connected state. In some other embodiments of the present application, an exemplary configured condition is periodic TAU, and the repeater will initiate the periodic TAU to enter the RRC connected state. The repeater may propose its desired periodicity of the periodic TAU to the CN in some scenarios.

As stated above, for an NCR, the NCR-Fwd is controlled by a RAN node, e.g., a gNB via transmitting side control information to the NCR-MT, and thus only state transition of the NCR-MT will be considered herein. More detailed embodiments of the present application will be illustrated in the following in view of an exemplary NCR-MT or the like. State transition of the NCR-MT is deemed as the state transition of the NCR in the following embodiments. In addition, in all the following embodiments of the present application, it is assumed that the NCR has accessed to the network and has been identified (or authenticated, or authorized) by the network, e.g., by the CN or the RAN node.

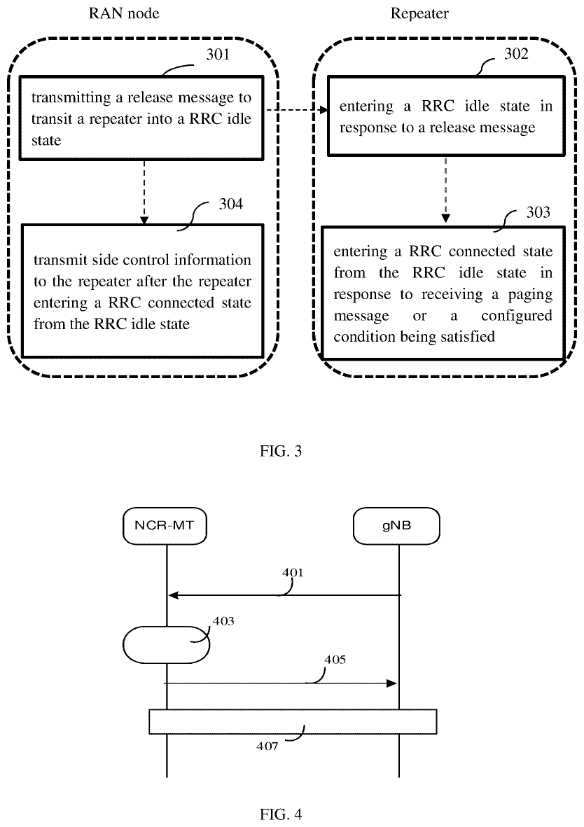

FIG. 4 is a flow chart illustrating an exemplary procedure of supporting state transition of NCR-MT according to some embodiments of the present application, wherein a paging message from the gNB or the like is used to transit the NCR-MT from the RRC idle state to the RRC connected state.

Referring to FIG. 4, a gNB or the like will transmit a release message, e.g., a RRC release message to the NCR-MT in step 401. A paging configuration may also be transmitted in the release message in some embodiments of the present application. The paging configuration at least includes a RAN identity of the NCR-MT. In some other embodiments of the present application, the paging configuration may be transmitted in other message(s) or signalling. The NCR-MT will be explicitly or implicitly indicated to store the paging configuration at least in the RRC idle state.

In response to the release message, the NCR-MT will enter the RRC idle state in step 403. The NCR-MT will also store the paging configuration at least in the RRC idle state, e.g., storing the paging configuration alone or storing the UE context including the paging configuration in response to receiving the release message.

In the case that the gNB needs the NCR-MT to transit to the RRC connected state again, the gNB will paging the NCR-MT in step 405 with a paging message based on the paging configuration including the RAN identity of the NCR-MT.

After receiving the paging message for itself, the NCR-MT will initiate a RRC setup procedure and trigger random access channel (RACH) in step 407 to establish a RRC connection with the gNB. After the NCR-MT enters the RRC-connected state from the RRC idle state, the gNB will send the side control information to the NCR-MT to control the NCR-Fwd if necessary.

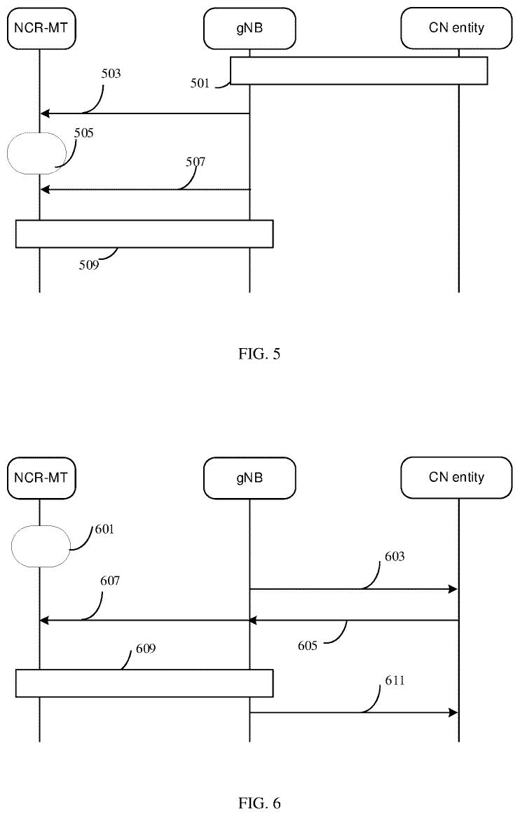

FIG. 5 is a flow chart illustrating an exemplary procedure of supporting state transition of NCR-MT according to some other embodiments of the present application, wherein a paging message from the gNB or the like is also used to transit the NCR-MT from the RRC idle state to the RRC connected state. However, the paging message is based on a CN identity of the NCR-MT rather than the RAN identity of the NCR-MT.

Referring to FIG. 5, it is assumed that the NCR-MT registers in the CN, e.g., the AMF of the CN and has a CN identity, e.g., temporary mobile subscriber identity (TSMI). The gNB or the like will obtain the CN identity of the NCR-MT from the CN in step 501, which may be before or after sending the NCR to the RRC idle state. For example, the gNB will transmit a request to a CN entity, e.g., the AMF to request the CN identity of the NCR-MT. After receiving the CN identity of the NCR-MT, the gNB will store the CN identity of the NCR-MT at least to potentially paging the NCR-MT.

Similarly, the gNB will transmit a release message, e.g., a RRC release message to the NCR-MT in step 503. In response to the release message, the NCR-MT will enter the RRC idle state in step 505.

In the case that the gNB needs the NCR-MT to transit to the RRC connected state again, the gNB will paging the NCR-MT in step 509 with a paging message based on the CN identity of the NCR-MT.

Similarly, after receiving the paging message for itself, the NCR-MT will initiate a RRC setup procedure and trigger RACH in step 509 to establish a RRC connection with the gNB. After the NCR-MT enters the RRC-connected state from the RRC idle state, the gNB may send the side control information to the NCR-MT to control the NCR-Fwd if necessary.

FIG. 6 is a flow chart illustrating an exemplary procedure of supporting state transition of NCR-MT according to some yet embodiments of the present application, wherein a paging message is also used to transit the NCR-MT from the RRC idle state to the RRC connected state while the paging message is generated by the CN rather than the gNB.

Referring to FIG. 6, in response to a release message from a gNB or the like, the NCR-MT in the RRC connected state will enter the RRC idle state in step 601.

Similarly, the gNB may need the NCR-MT to transit to the RRC connected state again. For example, the gNB would like to control the NCR-Fwd via the NCR-MT by sending control information to the NCR-MT, and the NCR-MT needs to setup the RRC connection with the gNB and enter the RRC connected mode. The gNB will request the CN, e.g., the AMF of the CN to paging the NCR-MT in step 603, e.g., by transmitting a request of requesting paging the NCR-MT by the CN with a user identity of the NCR-MT. Exemplary user identity of the NCR-MT is international mobile subscriber identity (IMSI), subscription permanent identifier (SUPI) or international mobile equipment identity (IMEI) etc. The AMF can determine (or infer) the CN identity of the NCR-MT based on the received user identity of the NCR-MT.

In step 605, the AMF will transmit a response to the AMF with a paging message to the NCR-MT based on the CN identity of the NCR-MT. The gNB will paging the NCR-MT in step 607 by transmitting the received paging message to the NCR-MT.

Similarly, after receiving the paging message for itself, the NCR-MT will initiate a RRC connection setup procedure and enter the RRC connected state in step 609. After the NCR-MT enters the RRC-connected state from the RRC idle state, the gNB may send the side control information to the NCR-MT to control the NCR-Fwd if necessary. In some embodiments of the present application, in response to the RRC connection being established, the gNB may also transmit information indicating success of paging the NCR-MT to the CN, e.g., to the AMF in step 611.

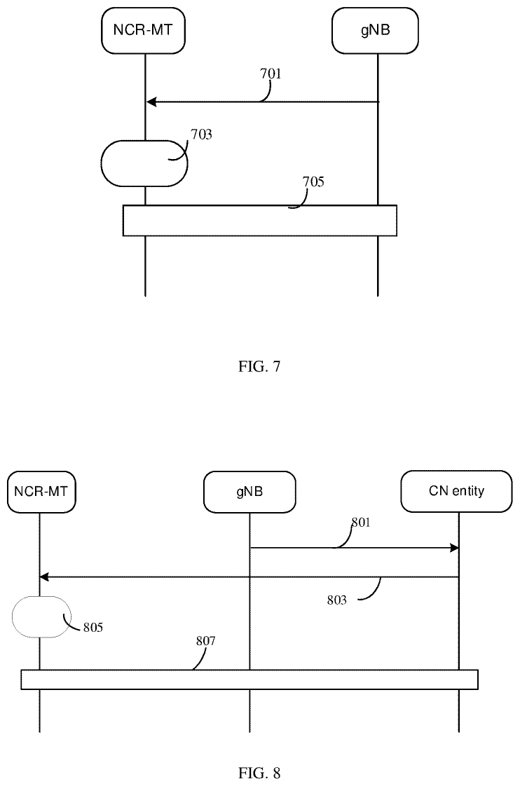

Different from FIGS. 4 to 6, configured condition(s) will be used in embodiments illustrated in FIGS. 7 and 8. Regarding FIG. 7, it is a flow chart illustrating an exemplary procedure of supporting state transition of NCR-MT according to some yet other embodiments of the present application, wherein a timer related to RRC connection establishment is configured.

Referring to FIG. 7, similarly, a gNB or the like will transmit a release message, e.g., a RRC release message to the NCR-MT in step 701. Configuration of a timer related to RRC connection establishment may also transmitted in the release message in some embodiments of the present application, wherein the NCR-MT is expected to initiate a RRC connection establishment procedure in response to the expiry of the timer. In some other embodiments of the present application, the configuration of the timer may be transmitted in other message(s) or signalling, e.g., a RRC reconfiguration message. The NCR-MT will be explicitly or implicitly indicated to store the configuration of the timer at least in the RRC idle state.

In response to the release message, the NCR-MT will enter the RRC idle state in step 703. The NCR-MT will also store the configuration of the timer at least in the RRC idle state, e.g., storing the configuration of the timer alone or storing the UE context including the configuration of the timer in response to receiving the release message.

The NCR-MT will start the timer in response to entering the RRC idle state. The NCR-MT will also maintain the timer in the RRC idle state. In step 705, the NCR-MT will initiate a RRC setup procedure in response to the expiry of the timer. After the NCR-MT enters the RRC-connected state from the RRC idle state, the gNB may send the side control information to the NCR-MT to control the NCR-Fwd if necessary.

FIG. 8 is a flow chart illustrating an exemplary procedure of supporting state transition of NCR-MT according to some yet other embodiments of the present application, wherein periodic TAU is used as the configured condition.

Referring to FIG. 8, before the NCR-MT entering to the RRC idle state, periodic TAU with a periodicity will be configured for the NCR-MT by the CN to trigger the NCR-MT enter the RRC connected state. For example, in step 801, the gNB or the like will transmit information indicating desired periodicity of the TAU to a CN entity, e.g., the AMF. In some other embodiments of the present application, in step 801, the gNB may only indicate a need of periodic TAU to the NCR-MT without a specific periodicity. The AMF may use the periodicity desired by the gNB as the periodicity of the TAU, or determine a periodicity of the TAU by itself. In step 803, the AMF will transmit configuration information of the periodic TAU to the NCR-MT before the NCR-MT enters the RRC idle mode in step 805.

Based on the configuration information on the periodic TAU, the NCR-MT in the RRC idle state will initiate the periodic TAU with the configured periodicity and enter in RRC connected mode in step 807. Similarly, after the NCR-MT in the RRC idle enters the RRC-connected state from the RRC idle state, the gNB may send the side control information to the NCR-MT to control the NCR-Fwd if necessary.

Besides the methods, embodiments of the present application also propose an apparatus of supporting state transition of repeater.

For example, FIG. 9 illustrates a block diagram of an apparatus of supporting state transition of repeater according to some embodiments of the present application.

As shown in FIG. 9, the apparatus 900 may include at least one non-transitory computer-readable medium 901, at least one receiving circuitry 902, at least one transmitting circuitry 904, and at least one processor 906 coupled to the non-transitory computer-readable medium 901, the receiving circuitry 902 and the transmitting circuitry 904. The at least one processor 906 may be a CPU, a DSP, a microprocessor etc. The apparatus 900 may be a RAN node, e.g., a gNB or a repeater configured to perform a method illustrated in the above or the like.

Although in this figure, elements such as the at least one processor 906, transmitting circuitry 904, and receiving circuitry 902 are described in the singular, the plural is contemplated unless a limitation to the singular is explicitly stated. In some embodiments of the present application, the receiving circuitry 902 and the transmitting circuitry 904 can be combined into a single device, such as a transceiver. In certain embodiments of the present application, the apparatus 900 may further include an input device, a memory, and/or other components.

In some embodiments of the present application, the non-transitory computer-readable medium 901 may have stored thereon computer-executable instructions to cause a processor to implement the method with respect to the RAN node, e.g., a gNB as described above. For example, the computer-executable instructions, when executed, cause the processor 906 interacting with receiving circuitry 902 and transmitting circuitry 904, so as to perform the steps with respect to a gNB or the like as depicted above.

In some other embodiments of the present application, the non-transitory computer-readable medium 901 may have stored thereon computer-executable instructions to cause a processor to implement the method with respect to the repeater as described above. For example, the computer-executable instructions, when executed, cause the processor 906 interacting with receiving circuitry 902 and transmitting circuitry 904, so as to perform the steps with respect to a repeater or the like as illustrated above.

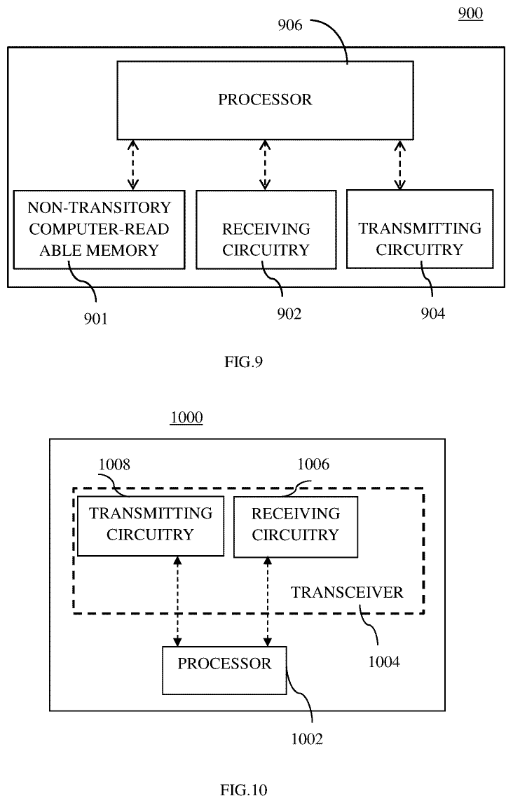

FIG. 10 is a block diagram of an apparatus of supporting state transition of repeater 1000 according to some other embodiments of the present application.

Referring to FIG. 10, the apparatus 1000, for example a gNB or a repeater may include at least one processor 1002 and at least one transceiver 1004 coupled to the at least one processor 1002. The transceiver 1004 may include at least one separate receiving circuitry 1006 and transmitting circuitry 1004, or at least one integrated receiving circuitry 1006 and transmitting circuitry 1004. The at least one processor 902 may be a CPU, a DSP, a microprocessor etc.

According to some embodiments of the present application, when the apparatus 1000 is a repeater, the processor is configured to: enter a RRC idle state in response to a release message; and enter a RRC connected state from the RRC idle state in response to receiving a paging message or a configured condition being satisfied.

According to some other embodiments of the present application, when the apparatus 1000 is a gNB or the like, the processor is configured to: transmit a release message to transit a repeater into a RRC idle state; and transmit side control information to the repeater after the repeater entering a RRC connected state from the RRC idle state, wherein the repeater entering the RRC connected state is in response to a paging message from the RAN node or a configured condition being satisfied.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A repeater for wireless communication, comprising:
at least one memory; and
a at least one processor coupled with the at least one memory and configured to cause the repeater to:
enter a radio resource control (RRC) idle state in response to a release message; and
enter an RRC connected state from the RRC idle state in response to receiving a paging message or a configured condition being satisfied.

2. The repeater of claim 1, wherein the at least one processor is configured to cause the repeater to receive the paging message from a radio access network (RAN) node based on a paging configuration including a RAN identity of the repeater.

3. The repeater of claim 2, wherein the at least one processor is configured to cause the repeater to transmit the paging configuration in the release message.

4. The repeater of claim 2, wherein the at least one processor is configured to cause the repeater to store the paging configuration or store a user equipment (UE) context including the paging configuration at least in the RRC idle state.

5. The repeater of claim 1, wherein the configured condition is expiry of a timer related to RRC connection establishment, and the at least one processor is configured to cause the repeater to:
start the timer in response to entering the RRC idle state; and
initiate a RRC setup procedure in response to the expiry of the timer.

6. The repeater of claim 1, wherein the at least one processor is configured to cause the repeater to store the configured condition or store a user equipment (UE) context including the configured condition at least in the RRC idle state.

7. A radio access network (RAN) node for wireless communication, comprising:
at least one memory; and
at least one processor coupled with the at least one memory and configured to cause the RAN node to:
transmit, to a repeater, a release message to transition the repeater into a radio resource control (RRC) idle state; and
transmit, to the repeater, side control information after the repeater a enters an RRC connected state from the RRC idle state, wherein the repeater enters the RRC connected state in response to a paging message from the RAN node or a configured condition being satisfied.

8. The RAN node of claim 7, wherein the at least one processor is configured to transmit, to the repeater, the paging message based on a paging configuration including a RAN identity of the repeater.

9. The RAN node of claim 8, wherein the at least one processor is configured to transmit the paging configuration in the release message.

10. The RAN node of claim 7, wherein the at least one processor is configured to cause the RAN node to transmit, to the repeater, the paging message based on a core network (CN) identity of the repeater.

11. The RAN node of claim 10, wherein the at least one processor is configured to cause the RAN node to request the CN identity of the repeater from a CN entity.

12. The RAN node of claim 10, wherein the at least one processor is configured to cause the RAN node to:
transmit, to a CN entity, a request for requesting paging the repeater by a CN with a user identity of the repeater for determining the CN identity;
receive, from the repeater, a response including the paging message; and
transmit, to the repeater, the paging message.

13. The RAN node of claim 7, wherein the configured condition is expiry of a timer related to RRC connection establishment, and the at least one processor is configured to cause the RAN node to transmit configuration of the timer in the release message.

14. The RAN node of claim 7, wherein the configured condition is periodic tracking area updating (TAU), and the at least one processor is configured to cause the RAN node to transmit information indicating desired periodicity of the TAU to a CN entity.

15. A method performed by a repeater, the method comprising:
entering a radio resource control (RRC) idle state in response to a release message; and
entering an RRC connected state from the RRC idle state in response to receiving a paging message or a configured condition being satisfied.

16. The method of claim 15, further comprising:
receiving the paging message from a radio access network (RAN) node based on a paging configuration including a RAN identity of the repeater.

17. The method of claim 16, further comprising:
transmitting the paging configuration in the release message.

18. The method of claim 15, wherein:
the configured condition is expiry of a timer related to RRC connection establishment; and the method further comprising:
starting the timer in response to entering the RRC idle state; and
initiating a RRC setup procedure in response to the expiry of the timer.

19. A method performed by a radio access network (RAN) node, the method comprising:
transmitting, to a repeater, a release message to transition the repeater into a radio resource control (RRC) idle state; and
transmit, to the repeater, side control information after the repeater enters an RRC connected state from the RRC idle state, wherein the repeater enters the RRC connected state in response to a paging message from the RAN node or a configured condition being satisfied.

20. The method of claim 19, further comprising:
transmitting, to the repeater, the paging message based on a paging configuration including a RAN identity of the repeater; and
transmitting the paging configuration in the release message.
